(19) United States
(12) Patent Application Publication
(10) Pub. No.: US 2024/0403945 A1
(43) Pub. Date: Dec. 5, 2024

(54) SYSTEM AND METHOD OF PROVIDING SERVICE FOR MONITORING MANUFACTURING STATUS OF VEHICLE

(71) Applicants: Hyundai Motor Company, Seoul (KR); Kia Corporation, Seoul (KR)

(72) Inventor: Minhan Kim, Seongnam-si (KR)

(21) Appl. No.: 18/509,540

(22) Filed: Nov. 15, 2023

(30) Foreign Application Priority Data
Jun. 5, 2023 (KR) 10-2023-0072198

(51) Int. Cl. G06Q 30/0601; G06T 11/60

(52) U.S. Cl. CPC G06Q 30/0643; G06T 11/60; G06T 2200/24

(57) ABSTRACT

Embodiments can include a system, or a method, for providing a service to monitor a manufacturing status of a vehicle. In an embodiment, a system can include a production management system configured to monitor an assembly process progress state of the vehicle to generate work status information, and a metaverse service operation system configured to build a metaverse environment to include a virtual factory environment modeled as an image-based virtual space of a factory where the vehicle is manufactured, to update the metaverse environment to depict a process currently in progress for the vehicle within the virtual factory environment based on the work status information, and to transmit data for executing the metaverse environment to a customer terminal.

### CROSS-REFERENCE TO RELATED APPLICATIONS

This application claims the benefit of Korean Patent Application No. 10-2023-0072198, filed on Jun. 5, 2023, which application is hereby incorporated herein by reference.

### TECHNICAL FIELD

The present disclosure relates to a system and a method for providing a service for monitoring a manufacturing status of a vehicle.

### BACKGROUND

The term metaverse is a combination of the words “universe,” meaning the real world, and “meta,” meaning “fictional, abstract,” and refers to a three-dimensional virtual world, but it also describes a new way of using online space. The metaverse itself is virtual, but the effects of experiences within the metaverse are real. As a result, companies have been recently trying to apply the metaverse to marketing.

### SUMMARY

The present disclosure attempts to provide a system and a method of providing a service for monitoring a manufacturing status of a vehicle, which enables a customer to monitor a manufacturing status of a vehicle the customer has purchased by using a metaverse environment.

An example embodiment of the present disclosure provides a system for providing a service for monitoring a manufacturing status of a vehicle, the system including a production management system configured to monitor an assembly process progress state of the vehicle to generate work status information, and a metaverse service operation system configured to build a metaverse environment to include a virtual factory environment modeled as an image-based virtual space of a factory where the vehicle is manufactured, to update the metaverse environment to depict a process currently in progress for the vehicle within the virtual factory environment based on the work status information, and to transmit data for executing the metaverse environment to a terminal of a customer who purchased the vehicle.

The metaverse service operation system may place a graphical object representing the vehicle in an area within the virtual factory environment where the process currently in progress is being performed and depict the process currently in progress by using the graphical object.

The metaverse service operation system may identify a component or module being assembled in the vehicle based on the work status information, and provide information about the component or the module in the metaverse environment.

When the vehicle has left a factory and is being transported, the metaverse service operation system may update the metaverse environment to depict a situation where the vehicle is being transported in the metaverse environment.

The metaverse service operation system may build the metaverse environment to further include a virtual vehicle depicted to have the same vehicle environment as the vehicle.

The metaverse service operation system may build the metaverse environment to further include at least one item for providing promotional information.

The metaverse service operation system may build the metaverse environment to include a virtual market for selling customization components or modules, and transmit information about customization components or modules purchased by the customer in the virtual market to the production management system. The production management system may make the customization components or modules purchased by the customer be actually mounted to the vehicle.

When a non-purchasing customer who has not purchased a vehicle attempts to access the metaverse environment, the metaverse service operation system may restrict access of the non-purchasing customer to some functions provided by the metaverse environment.

The metaverse service operation system may build the metaverse environment to include an avatar of the customer, and implement the avatar to perform certain activities within the metaverse environment through interaction with the terminal.

The metaverse service operation system may add a character representing the vehicle within the metaverse environment, set a character name for the character through interaction with the terminal, and give a conversation function with the terminal to the character.

When a message to be transmitted to a worker assembling the vehicle is received from the terminal, the metaverse service operation system may transmit the message to a terminal of the worker.

Another example embodiment of the present disclosure provides a method of providing a service for monitoring a manufacturing status of a vehicle, the method including building a metaverse environment to include a virtual factory environment modeled as an image-based virtual space of a factory where the vehicle is manufactured, monitoring an assembly process progress state of the vehicle to generate work status information, and updating the metaverse environment to depict a process currently in progress for the vehicle within the virtual factory environment based on the work status information, and transmitting data for executing the metaverse environment to a terminal of a customer who purchased the vehicle.

The updating may include placing a graphical object representing the vehicle of the customer in an area within the virtual factory environment where the process currently in progress is being performed, and adding a graphical effect that depicts the process currently in progress to the metaverse environment.

The method may further include performing an authentication procedure for the customer based on information received from the terminal, and blocking access of the terminal to the metaverse environment when authentication to the customer fails.

The method may further include, when a non-purchasing customer who has not purchased a vehicle attempts to access the metaverse environment, restricting access of the non-purchasing customer to some functions provided by the metaverse environment.

According to an embodiment of the present disclosure, it is possible to support a customer to monitor the manufacturing status of a vehicle purchased by the customer by utilizing the metaverse environment.

### BRIEF DESCRIPTION OF THE DRAWINGS

The above and other features and advantages of the present disclosure can be more apparent from the following detailed description taken in conjunction with the accompanying drawings, in which:

FIG. 1 is a diagram schematically illustrating a system for providing a service for monitoring a manufacturing status of a vehicle according to an embodiment;

FIG. 2A illustrates an example of a virtual factory generation system according to an embodiment, in which some assembly environments are modeled in a two-dimensional image-based virtual space;

FIG. 2B illustrates an example of a virtual factory generation system according to an embodiment, in which some assembly environments are modeled in a three-dimensional image-based virtual space;

FIG. 3 is a diagram illustrating an example of a virtual environment according to an embodiment, which is synchronized with an actual work status of a vehicle;

FIG. 4 is a diagram illustrating an example of providing information requested by a customer within a virtual environment according to an embodiment;

FIG. 5 is a diagram illustrating an example of a message transmitted from a customer to a worker according to an embodiment; and

FIG. 6 is a diagram schematically illustrating a method of providing a service for monitoring a manufacturing status of a vehicle according to an embodiment.

### DETAILED DESCRIPTION OF ILLUSTRATIVE EMBODIMENTS

Hereinafter, example embodiments of the present specification will be described in detail with reference to the accompanying drawings, and the same or similar constituent elements can be denoted by a same reference numeral, regardless of a reference numeral, and a repeated description thereof may be omitted. Suffixes, “module” and/or “unit” for a constituent element used for the description below are given or mixed in consideration of easiness of the writing of the specification, and the suffix itself does not necessarily have a discriminated meaning or role. Further, in describing example embodiments of the present disclosure, when it is determined that detailed description relating to well-known functions or configurations may make the subject matter of the example embodiment disclosed in the present disclosure unnecessarily ambiguous, the detailed description may be omitted. Further, the accompanying drawings are provided for helping to understand example embodiments of the present specification, and the technical spirit of the present specification is not necessarily limited by the accompanying drawings, and it can be appreciated that an embodiment can include all of the modifications, equivalent matters, and substitutes included in the spirit and the technical scope of the present disclosure.

Terms including an ordinary number, such as “first” and “second,” can be used for describing various constituent elements, but the constituent elements are not necessarily limited by such terms. Such terms can be used merely to discriminate one constituent element from another constituent element.

In the present disclosure, it can be appreciated that the terms “including” and “having” are intended to designate the existence of characteristics, numbers, steps, operations, constituent elements, and components described in the specification or combinations thereof, and do not exclude a possibility of the existence or addition of one or more other characteristics, numbers, steps, operations, constituent elements, and components, or combinations thereof.

In the present disclosure, each of the terms, such as “A or B,” “at least one of A and B,” “at least one of A or B,” “A, B, or C,” “at least one of A, B, and C,” and “at least one of A, B, or C” may include all possible combinations of items listed together in the corresponding phrase.

A program implemented as a set of instructions embodying a control algorithm to control another configuration may be installed in a configuration for controlling another configuration under a specific control condition among configurations according to an example embodiment. The control configuration may process input information and stored information according to an installed program to generate output information. The control configuration may include non-volatile memory for storing programs and memory for storing information.

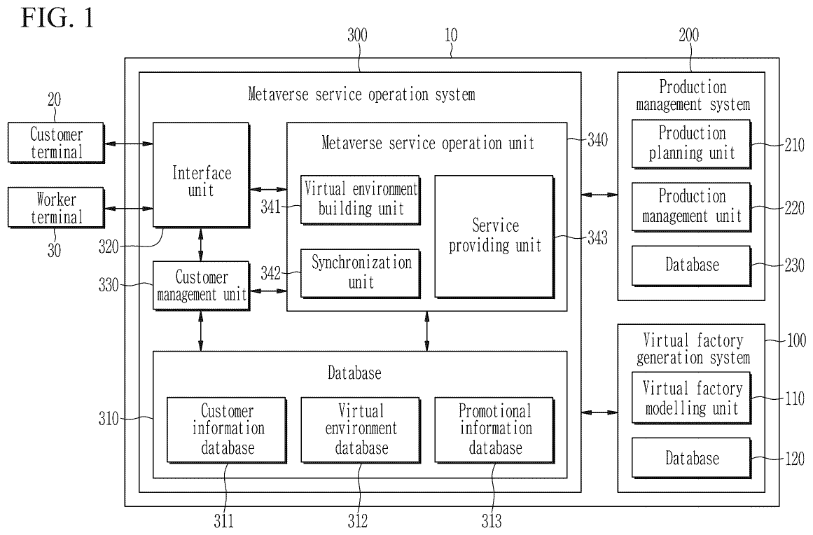

FIG. 1 is a diagram schematically illustrating a vehicle manufacturing status monitoring service providing system according to an embodiment.

Referring to FIG. 1, a system 10 for providing a service to monitor a vehicle manufacturing status may include a virtual factory generation system 100, a production management system 200, and a metaverse service operation system 300.

The virtual factory generation system 100 may generate an image-based virtual factory model that depicts a production environment, such as a factory in which a physical vehicle is produced. The virtual factory generation system 100 may include a virtual factory modeling unit 110 and a database 120.

The virtual factory modeling unit 110 may model the environment in which the vehicle assembly process is performed as a two-dimensional or three-dimensional image-based virtual space.

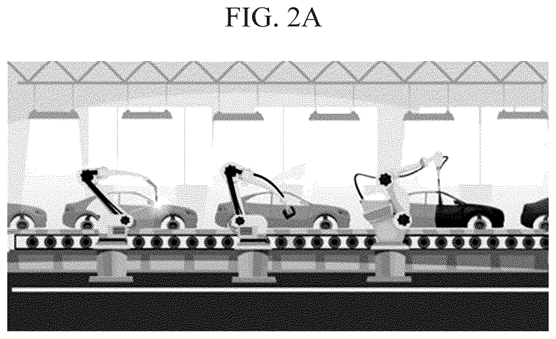

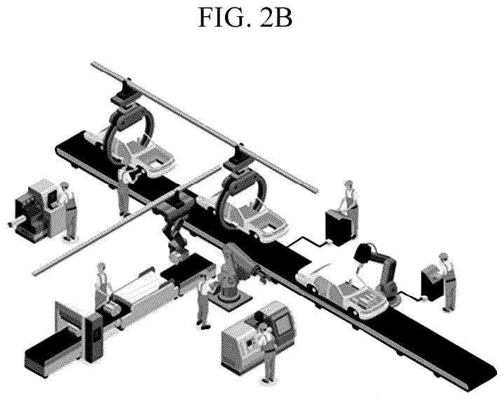

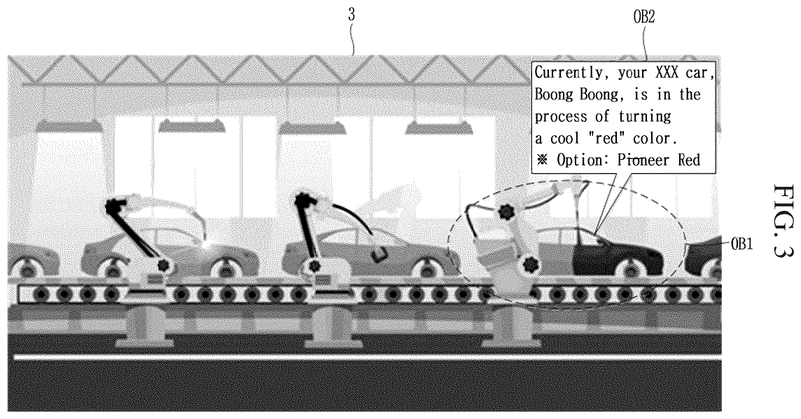

FIG. 2A illustrates an example of modeling a partial assembly environment as a two-dimensional image-based virtual space, according to an embodiment. FIG. 2B illustrates an example of modeling a partial assembly environment as a three-dimensional image-based virtual space, according to an embodiment. The virtual factory modeling unit 110 may model the environment in which each assembly process is performed as an image-based virtual space by using various graphical objects, as illustrated in FIGS. 2A and 2B. In the process of modeling the vehicle assembly environment in a virtual space, the degree of representation (approximate or specific) of the assembly environment can vary depending on the application equipment. As illustrated in FIGS. 2A and 2B, the virtual space may include graphical objects representing robots/equipment performing the assembly process, graphical objects (for example, avatars) representing workers performing the assembly process, and the like.

The virtual factory modeling unit 110 may generate a virtual factory model by combining the virtual spaces modeled in the above-described manner in a process sequence. In a real-world vehicle production environment, the sequence of processes at each factory may vary depending on various factors, including the location of the corresponding factory and the vehicle model being assembled at the corresponding factory. In a real-world vehicle production environment, each factory may have its own assembly process sequence. Therefore, the virtual factory modeling unit 110 may combine the virtual spaces according to the assembly process sequence of the corresponding factory to generate a virtual factory model when generating a virtual factory model corresponding to each factory. The number and combination order of virtual spaces that make up a virtual factory model may or may not be the same as the number and process order of assembly processes performed within the corresponding factory.

The virtual factory modeling unit 110 may configure the virtual factory model to add a graphical object to each virtual space making up the virtual factory model, or to remove a graphical object placed in each virtual space. In addition, the virtual factory modeling unit 110 may generate a virtual factory model such that graphical objects (for example, avatars) representing customers/workers/managers may be able to implement graphical effects of moving between virtual spaces making up the virtual factory model.

When a virtual factory model is generated, the virtual factory modeling unit 110 may store and manage the generated virtual factory model in the database 120.

The production management system 200 may establish a production plan for each vehicle. And the production management system 200 may monitor and manage an assembly process for each vehicle based on the established production plan. The production management system 200 may include a production planning unit 210, a production management unit 220, and a database 230.

When a customer purchases a vehicle, the production planning unit 210 may generate production plan information for each vehicle based on the vehicle contract information created when the vehicle is purchased. The vehicle contract information may include customer information, unique identification information about the vehicle (for example, serial number), sales information (for example, sale location and sale price), detailed specification information (for example, vehicle model and option information), and the like. The production plan information for vehicles may include information about the production plan for each vehicle from when assembly begins to when the vehicle is delivered to the buyer. The production plan information for each vehicle may include factory information of a factory where each vehicle is input (for example, factory name and location information), an assembly initiation time point (such as predicted time point) of each vehicle, the sequence of assembly processes for each vehicle, the predicted time point of completion of each assembly process, and a plan to perform quality inspection for each vehicle.

When the production plan information for each vehicle is generated, the production planning unit 210 may store the production plan information for each vehicle in the database 230 together with the corresponding vehicle contract information.

The production management unit 220 may monitor a status of the progress for the assembly process of each vehicle, and generate work status information indicating the progress status for the assembly process of each vehicle based on the monitoring results. The work status information for each vehicle may include information indicating a current location and an assembly status of each vehicle. For example, the work status information of each vehicle may include whether each vehicle has been put into a factory, factory information about the factory where each vehicle has been input into, the process information about the process currently in progress for each vehicle (for example, process name, process progress degree, and the like), component information about the components/modules assembled in each vehicle (for example, serial number of each component/module, and the like), and the like.

Vehicles that are input into the factory for assembly are transported by bogies (or conveyors) as the vehicles move through the assembly process, and the bogies that transport the vehicles may also be replaced as the process switches. In addition, the assembly process for a vehicle may be sequentially performed as the bogie (or conveyor) carrying the vehicle moves. Thus, the production management unit 220 may check the process step currently in progress and the degree of process progression for each vehicle based on identification information and location information of the bogie that is transporting each vehicle.

The production management unit 220 may receive information about a work history from robots/equipment/workers performing the assembly process, and based on the received information about the work history, may check the process steps currently in progress and the degree of progress of the process for each vehicle. A robot/equipment/worker on a production line may identify the unique identification information of a corresponding vehicle that has been moved to its work area, and transmit the identified unique identification information and information about the work history being performed to the production management system 200. The unique identification information of the vehicle may be information that is etched into the body of the vehicle in an engraving form to prevent forgery or tampering. Typically, only predetermined work may be performed in each area of the factory. Therefore, by tracking in which area a vehicle is located, it is possible to automatically identify what work is currently being performed on the corresponding vehicle. When a robot/equipment/worker transmits the unique identification information for the vehicle identified by the robot/machine/worker in its/his/her work area to the production management system 200, the production management unit 220 may identify the assembly process currently in progress for the corresponding vehicle based on the location of the robot/equipment/worker that transmitted the unique identification information.

The production management unit 220 may track each component/module (for example, chassis, engine, Power Electric (PE) system, and battery pack) being assembled into the vehicle based on the work history information received from the robot/equipment/worker performing the assembly process, and may generate component information for each vehicle based on the information obtained through the tracking. The robot/equipment/worker performing the assembly process may verify the unique identification information of each component/module being assembled into the vehicle in its/his/her work area, and transmit the verified unique identification information and the specification information of the corresponding component/module to the production management system 200.

When the unique identification information and the specification information of the component/module being assembled into the vehicle is received, the production management unit 220 may add the received component information (for example, unique identification information, specification information, and the like) of the component/module to the work status information of the corresponding vehicle.

When the work status information is obtained for each vehicle, the production management unit 220 may store and manage (for example, update) the obtained work status information in the database 230.

In the assembly process, the vehicle may be subjected to a quality inspection process in the unit of component/module or vehicle for each operation. The production management unit 220 may obtain quality inspection result information for each vehicle by collecting the quality inspection results whenever the quality inspection is performed on each vehicle. The quality inspection results information may include the quality inspection items performed for each vehicle and the quality inspection results.

When the quality inspection result information is obtained for each vehicle, the production management unit 220 may store and manage (for example, update) the quality inspection result information in the database 230.

The metaverse service operation system 300 may generate a virtual environment that is a metaverse environment by reproducing at least some of the operations (for example, a production planning operation, an assembly process input operation, an assembly operation, an assembly completion operation, a transfer operation, and a handover operation) between the purchase of a vehicle by a customer and the delivery of the vehicle to the customer in a two-dimensional or three-dimensional image-based virtual space. In addition, the metaverse service operation system 300 may provide a metaverse service that allows a customer to access the virtual environment through the customer terminal 20 and perform activities within the virtual environment, such as touring the production site, viewing manufacturing status for his/her vehicle, communicating with workers who are assembling his/her vehicle, and the like.

The metaverse service operation system 300 may include a database 310, an interface unit 320, a customer management unit 330, and a metaverse service operation unit 340.

The database 310 may include a customer information database 311, a virtual environment database 312, and a promotional information database 313.

The customer information database 311 may store and manage customer information for customers registered in the metaverse service operation system 300. For example, the customer information database 311 may store and manage personal information including each customer's name, address, phone number, gender, age, and the like. In addition, for example, the customer information database 311 may also store and manage authentication information (for example, ID, password, email address, phone number, reservation number, and unique identification number of the purchased vehicle) used for authentication processing for each customer. In addition, for example, the customer information database 311 may also store and manage vehicle contract information for each customer. The customer information database 311 may also store and manage setting information for each customer's virtual environment.

The virtual environment database 312 may store and manage the virtual factory models generated by the virtual factory generation system 100. The virtual environment database 312 may store and manage information about the virtual environments built for each customer. For example, the virtual environment database 312 may store data necessary to build (or reproduce) each customer's virtual environment (for example, image data, sound data, and text data), each customer's avatar setting information, each customer's virtual vehicle setting information, and each customer's vehicle character setting information (for example, nickname).

The promotional information database 313 may store and manage various information utilized for marketing the vehicle within the virtual environment. For example, the promotional information database 313 may store promotional information for promoting a vehicle brand. In addition, for example, the promotional information database 313 may store detailed specification information for each vehicle model. In addition, for example, the promotional information database 313 may store appearance information (image information), functional information, location information in the vehicle, Unique Selling Proposition (USP) information, operation methods, precautions, and the like of the components/modules used in the assembly of the vehicle.

The interface unit 320 may provide an interface with a customer terminal 20 and/or a worker terminal 30. The interface unit 320 may communicate with the customer terminal 20 and/or the worker terminal 30 through wired and/or wireless communication, and may transmit and receive data to and from the customer terminal 20 and/or the worker terminal 30. For example, the interface unit 320 may transmit corresponding data (for example, image data, and sound data) to the customer terminal 20 such that the virtual environment operated by the metaverse service operation system 300 may be executed in the form of a User Interface (UI)/User Experience (UX) on the customer terminal 20. In addition, for example, the interface unit 320 may also receive authentication information for authentication processing of the customer, messages to be transmitted to the worker, and the like from the customer terminal 20. In addition, for example, the interface unit 320 may receive control information for operating the virtual environment from the customer terminal 20. In addition, for example, the interface unit 320 may also transmit messages entered by the customer to the worker terminal 30.

When a customer wishes to access the virtual environment operated by the metaverse service operation system 300, the customer may attempt to access the metaverse service operation system 300 by executing a web or an application on the customer terminal 20. The customer management unit 330 may perform authentication processing for the customer when the customer attempts to access the metaverse service operation system 300 through the customer terminal 20. The customer management unit 330 may receive authentication information for customer authentication from the customer terminal 20, and compare the received authentication information with authentication information stored in the customer information database 311 to perform authentication processing.

The customer management unit 330 may manage customers accessing the metaverse service operation system 300 by dividing the accessing customers into purchasers who have actually purchased a vehicle from a manufacturer and non-purchasers who have not purchased a vehicle. The customer management unit 330 may restrict access to some of the metaverse services operated by the metaverse service operation system 300 (for example, manufacturing status monitoring services, and function to communicate with workers) based on whether the customer has purchased a vehicle.

The metaverse service operation unit 340 may generate a virtual environment and operate a metaverse service so that customers may be provided with a tour service, a manufacturing status monitoring service, a communication service, an advertising service, and the like, within the virtual environment. The metaverse service operation unit 340 may include a virtual environment building unit 341, a synchronization unit 342, and a service providing unit 343.

The virtual environment building unit 341 may build a virtual environment. The virtual environment may include a virtual factory environment where the assembly process of the vehicle purchased by the customer progresses. The virtual environment building unit 341 may select a virtual factory model of the factory that produces the customer's vehicle from among the virtual factory models stored in the virtual environment database 312. For example, the virtual environment building unit 341 may select a virtual factory model corresponding to the factory producing the vehicle based on contract information or unique identifying information of the vehicle purchased by the customer from the virtual environment database 312. In addition, for example, when the customer is a non-purchasing customer, the virtual environment building unit 341 may select a virtual factory model of a factory that produces a corresponding vehicle model based on the vehicle model selected by the customer from the virtual environment database 312. The virtual environment building unit 341 may build a virtual factory environment to be included in the virtual environment by using the selected virtual factory model.

The virtual environment may further include a virtual space for sharing vehicle production plans before the vehicle enters the factory, or for sharing a vehicle transportation status after the vehicle leaves the factory.

The virtual environment may further comprise a virtual vehicle that is a reproduced three-dimensional image-based virtual object of the vehicle purchased by the customer. A virtual vehicle may be implemented to have the same vehicle environment as the physical vehicle that the customer purchased. For example, a virtual vehicle may be implemented to reflect the color, options, and customizations mounted of the physical vehicle purchased by the customer. Virtual vehicle may also be given nicknames by customers. A virtual vehicle may be configured to allow a customer to drive or ride in the vehicle and manipulate the vehicle within the virtual environment.

The virtual environment may further include items to provide customers with promotional information related to the vehicle. The virtual environment building unit 341 may place items for providing promotional information in the virtual space making up the virtual environment.

The virtual environment may also further include a virtual market space. In a virtual market space, customers may buy vehicles or sell their vehicle. In the virtual market space, customers may additionally purchase customizing components/modules. The virtual environment building unit 341 may design the virtual market space to display graphical objects representing vehicles available for purchase within the virtual market, provide promotional information about the vehicles displayed, and direct customers to a site where they can actually purchase or obtain the selected vehicle when any one vehicle is selected by the customer. The virtual environment building unit 341 may design the virtual market space to place customizing components/modules available for purchase within the virtual market, and to direct customers to a site where they can actually purchase or obtain the selected component/module when any one component/module is selected by the customer. The virtual environment building unit 341 may also design a virtual market space to allow customers to buy other customers' vehicles or sell their own vehicles within the virtual market.

When the virtual environment of the customer is built, the synchronization unit 342 may synchronize the virtual environment to reflect the actual manufacturing status of the vehicle purchased by the customer in conjunction with the production management system 200.

When the vehicle purchased by the customer is being manufactured at the factory, the synchronization unit 342 may update the virtual environment to depict the assembly process currently in progress for the vehicle within the virtual environment, such as the virtual factory environment. The synchronization unit 342 may receive work status information for the customer's vehicle from the production management system 200. Based on the work status information of the vehicle, the synchronization unit 342 may check what work is currently in progress and the extent to which the work has been completed for the customer's vehicle. Additionally, the synchronization unit 342 may update the virtual environment to depict the work currently in progress for the vehicle within the virtual environment.

For example, when a paint job is being performed on the vehicle, the customer's vehicle (a graphical object representing the customer's vehicle) is put into the virtual space where the paint job is being performed in the virtual environment, and the situation where the customer's vehicle is being painted may be reproduced or simulated in the corresponding virtual space by using graphical effects, including animation effects and images of the actual work, for example.

When the vehicle purchased by the customer leaves the factory and is moving, the synchronization unit 342 may update the virtual environment to reproduce the situation where the vehicle is being transported within the virtual environment by using animation effects and the like.

FIG. 3 is a diagram illustrating an example of a virtual environment that is synchronized with an actual work status of a vehicle, according to an embodiment.

Referring to FIG. 3, when a customer's vehicle is currently being painted, a virtual environment 3 may be updated to include an image OB1 and text OB2 indicating that the customer's vehicle is being painted.

When a customer accesses his/her virtual environment through the customer terminal 20, the service providing unit 343 may provide metaverse services that support various activities of the customer within the virtual environment through interaction with the customer terminal 20.

When a customer accesses his/her virtual environment through the customer terminal 20, the service providing unit 343 may provide the customer terminal 20 with data (for example, image data and sound data) necessary to reproduce the virtual environment in the form of UI/UX on the customer terminal 20, and the customer terminal 20 receiving the data may reproduce the virtual environment on a screen of the customer terminal 20 by using the received data.

The virtual environment may be provided in a tour mode or exploratory mode, depending on the type of customer. The service providing unit 343 may provide the virtual environment in the tour mode to the customer terminal 20 when the customer is a non-purchasing customer, or when a tour request is received from a purchasing customer. In this case, the virtual environment includes a virtual factory environment that corresponds to the vehicle model selected by the customer, and the customer may be given the experience of touring the virtual factory environment by using graphical effects, such as moving within the virtual factory environment.

When a manufacturing status check for the customer's vehicle is requested from the vehicle purchasing customer, the service providing unit 343 may provide a virtual environment in an exploratory mode to the customer terminal 20. The service providing unit 343 may provide the virtual environment synchronized with the manufacturing status of the customer's vehicle by the synchronization unit 342 to the customer terminal 20.

The service providing unit 343 may interact with the customer terminal 20 to implement certain activities (for example, moving around, viewing information, receiving advertisements, and communicating with workers) within the virtual environment that the customer terminal 20 is accessing. In a state where the customer accesses the virtual environment through the customer terminal 20, the customer may manipulate the customer terminal 20 (for example, touch a particular graphical object) to generate a control input. The generated control input may be transmitted to the service providing unit 343 through the interface unit 320, and the service providing unit 343 may update the virtual environment so that a specific activity is implemented in the virtual environment that the customer terminal 20 is accessing based on the control input received from the customer terminal 20.

The customer may manipulate the customer terminal 20 to generate a control input to move within the virtual environment. The service providing unit 343 receiving the movement request from the customer terminal 20 may switch or shift the virtual environment displayed on the customer terminal 20, or implement a graphical effect of the customer's avatar moving within the virtual environment.

The customer may also manipulate the customer terminal 20 to generate a control input to view information related to his/her vehicle within the virtual environment. The service providing unit 343 receiving a request to provide information from the customer terminal 20 may transmit graphical objects representing the requested information to the customer terminal 20. For example, the customer may also manipulate the customer terminal 20 to generate a control input requesting information about the manufacturing status of the vehicle within the virtual environment. The service providing unit 343, receiving a request from the customer terminal 20 to provide information about the vehicle manufacturing status, may provide information describing the vehicle manufacturing status to the customer terminal 20 by using text, images of actual work, diagrams or graphs indicating the progress state of the process, and the like. In addition, for example, the customer may also manipulate the customer terminal 20 to generate a control input to request detailed information about his/her vehicle (for example, detailed specification information of the vehicle, basic options, additional options, and layout, location, function, and operation method of each component/module) within the virtual environment. The service providing unit 343 receiving the request for detailed information about the vehicle from the customer terminal 20 may provide detailed information about the customer's vehicle to the customer terminal 20 by using text, image, voice output, or the like. Additionally, for example, the customer may manipulate the customer terminal 20 to generate a control input to request inspection results for his/her vehicle within the virtual environment. The service providing unit 343 receiving the request for the inspection results for the customer's vehicle from the customer terminal 20 may provide inspection items and inspection results for the customer's vehicle to the customer terminal 20 based on inspection result information of the customer's vehicle received from the production management system 200.

When the customer terminal 20 receives the information requested by the customer from the metaverse service operation system 300, the customer terminal 20 may display the received information in the virtual environment by using graphical objects, such as speech bubbles, pop-up windows, and text, or may also output the received information by using voice output.

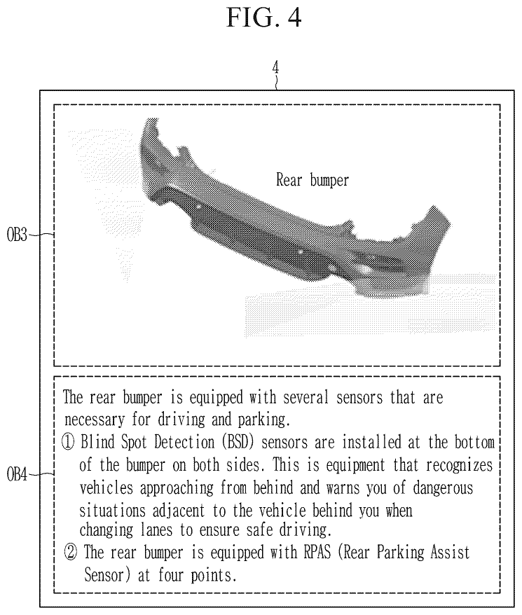

FIG. 4 is a diagram illustrating an example of providing information requested by a customer within a virtual environment, according to an embodiment. Using FIG. 4 as an example, when a process of assembling a rear bumper for a customer's vehicle is currently in progress and a detailed description of the module currently being assembled is requested from the customer terminal 20, the service providing unit 343 may transmit an image OB3 illustrating a layout of the rear bumper and text OB4 describing sensors to be mounted on the rear bumper to the customer terminal 20. The customer terminal 20 receiving the image OB3 and the text OB4 may display the received information OB3 and OB4 in the form of a pop-up window 4 in the virtual environment.

When it is determined that the customer has accessed his/her virtual environment through the customer terminal 20, the service providing unit 343 may automatically transmit assembly information for the current customer's vehicle to the customer terminal 20 even without a request from the customer terminal 20. The service providing unit 343 may also transmit relevant information to the customer terminal 20 when an event related to the customer's vehicle occurs. For example, when an event, such as a delayed release, a shortened release, and a process change, related to the customer's vehicle occurs, the service providing unit 343 may automatically transmit event-related information to the customer terminal 20 accessing the virtual environment without a request from the customer terminal 20. When the service providing unit 343 transmits the information to the customer terminal 20 without a request from the customer terminal 20, the customer terminal 20 may display the received information in the virtual environment in the form of a pop-up window, or may display received information by using a graphic object, such as an icon. In the latter case, the customer terminal 20 may display the information received from the service providing unit 343 in the virtual environment when the corresponding graphical object is selected by the customer.

The service providing unit 343 may also provide promotional information related to the vehicle to the customer within the virtual environment. When an avatar of the customer enters a particular space in the virtual environment, or when the customer manipulates the customer terminal 20 to select a particular item placed in the virtual environment, the service providing unit 343 may provide the customer terminal 20 with promotional information mapped to the corresponding space or the corresponding item. Based on the customer information stored in the customer information database 311, the service providing unit 343 may generate customer-specific promotional information and provide the generated customer-specific promotional information to the customer terminal 20 accessing the virtual environment. For example, when the customer's age is in the 50s, the service providing unit 343 may provide promotional information to the customer terminal 20 that recommends a vehicle that is suitable as a gift for the customer's child. When the customer terminal 20 receives the promotional information from the metaverse service operation system 300, the customer terminal 20 may display the received information within the virtual environment being displayed on the screen of the customer terminal 20 by using graphical objects, such as speech bubbles, pop-up windows, and text, or may also output the received promotional information using voice output.

The service providing unit 343 may active or inactivate the function of automatically transmitting assembly information, event occurrence information, promotional information, and the like, of the customer's vehicle to the customer terminal 20 according to the settings of the customer terminal 20. When the function of automatically receiving the aforementioned information is set to an inactivated state by the customer terminal 20, the service providing unit 343 may inactivate the function of transmitting the aforementioned information without a request from the customer terminal 20.

The service providing unit 343 may also support communication functions between customers and workers within the virtual environment. While connected to the virtual environment through the customer terminal 20, the customer may manipulate the customer terminal 20 to enter a message for encouragement, cheer-up, request, and the like, to the worker. When the service providing unit 343 receives the message to be delivered to the worker from the customer terminal 20, the service providing unit 343 may transmit the message to the worker terminal 30 for display on the screen of the worker terminal 30.

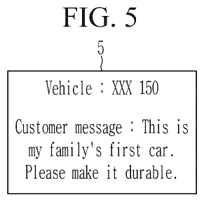

FIG. 5 is a diagram illustrating an example of a message transmitted from a customer to a worker, according to an embodiment. Referring to FIG. 5, the message entered by the customer may be transmitted the worker terminal 30 by the service providing unit 343 and displayed on the screen of the worker terminal 30 in the form of a pop-up window 5. When the language of the message entered by the customer differs from the language of the production site where the customer's vehicle is produced, the service providing unit 343 may automatically translate the customer's message and transmit the translated message to the worker. The service providing unit 343 may block the transmission of inappropriate messages, such as messages that degrade the worker's abilities or are profane, through pre-filtering.

The service providing unit 343 may support the customer to check the production schedule (for example, production plan, manufacturing status, and the like), transportation schedule (for example, transportation plan, transportation status, and the like), and the like, of the customer's vehicle in real time within the virtual environment. The service providing unit 343 may place items within the virtual environment that represent the production plan for the customer's vehicle (for example, when the vehicle enters the factory and when assembly is completed). The service providing unit 343 may also place items within the virtual environment that represent a transportation plan for the customer's vehicle (for example, when the transportation is to begin and when the transportation is to end). The service providing unit 343 may place items (for example, status bars, graphs, and text) within the virtual environment that represent the manufacturing status of the customer's vehicle. The service providing unit 343 may also place items within the virtual environment that indicate the current transportation status of the customer's vehicle (for example, a map image showing the current location of the customer's vehicle, GPS information indicating the current location of the customer's vehicle, and a graphical object indicating the current transportation means of the customer's vehicle). The customer may access the virtual environment through the customer terminal 20, and check the production schedule or transportation schedule of the customer's vehicle through the items arranged in the virtual environment displayed on the screen of the customer terminal 20.

The service providing unit 343 may also periodically transmit a message informing the manufacturing status or the transport status of the customer's vehicle to the customer terminal 20. Whenever an event related to the customer's vehicle occurs (for example, factory entry, start of assembly, completion of assembly, start of transportation, and completion of handover), the service providing unit 343 may place a graphical object indicating the occurrence of the event in the virtual environment, or transmit a message notifying the customer of the occurrence of the event, and the like, to the customer terminal 20. For example, when the customer actually takes his/her vehicle, the service providing unit 343 may add an item to celebrate the delivery of the vehicle within the virtual environment.

The service providing unit 343 may characterize/anthropomorphize the customer's vehicle within the virtual environment and give conversational capability to the customer's vehicle to help create a sort of rapport between the customer and the vehicle. The service providing unit 343 may add a character representing the customer's vehicle to the virtual environment. The customer may set a character, which is a graphical object, to replace his/her vehicle by accessing the virtual environment through the customer terminal 20, and set a character name (for example, a nickname), appearance, and the like, for the character. The character name given to the vehicle character by the customer may also be applied to the physical vehicle. For example, the character name given to the customer's vehicle in the virtual environment may be automatically set to the name of the vehicle in the real world, or used by the customer to invoke a voice recognition system in the real world. When the character representing the customer's vehicle is set by the customer, the service providing unit 343 may support the conversational capability of the corresponding character. The customer may access the virtual environment through the customer terminal 20 and engage in a voice or message-based conversation with the character representing his/her vehicle.

The service providing unit 343 may also support the purchase of customization components/modules, vehicle transactions, and the like, within the virtual environment. The customer may visit a virtual market in the virtual environment through the customer terminal 20 to purchase customization components/modules to add to his/her vehicle. When the purchase of the customization component/module within the virtual market is completed by the customer terminal 20, the service providing unit 343 may transmit the information of the customization component/module purchased by the customer along with the customer information to the production management system 200. The production management system 200 receiving the information may instruct to equip the physical vehicle with the customization component/module purchased by the customer.

The service providing unit 343 may also set the customer's virtual vehicle within the virtual environment as a non-fungible token (NFT) that has a property value. In this case, the virtual vehicle may also be treated as a tradeable object within the virtual market. A customer may transfer ownership of a virtual vehicle registered in the virtual environment by purchasing a physical vehicle and/or by purchasing the virtual vehicle in the virtual market in the virtual environment through the customer terminal 20. A customer who has taken over the ownership of the virtual vehicle may access the virtual environment through the customer terminal 20 to view information related to the purchased virtual vehicle (for example, the vehicle production process), and the corresponding virtual vehicle may remain as an NFT in the virtual environment even after the physical vehicle is scrapped.

In an embodiment, the virtual factory generation system 100, the production management system 200, and the metaverse service operation system 300 may each include at least one processor, and the functions of each of the systems 100, 200, and 300 described above may be performed by at least one processor configuring each of the systems 100, 200, and 300. For example, the metaverse service operation system 300 may include at least one processor, and the functions of the customer management unit 330 and the metaverse service providing unit 340 may be performed by at least one processor.

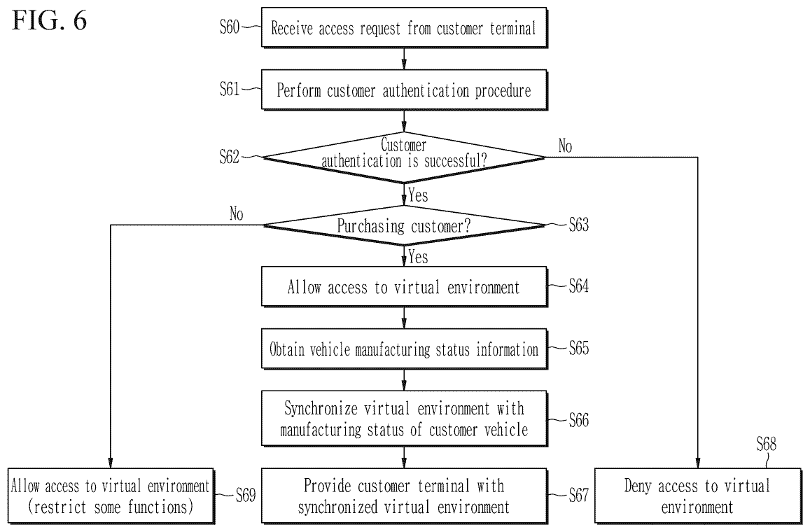

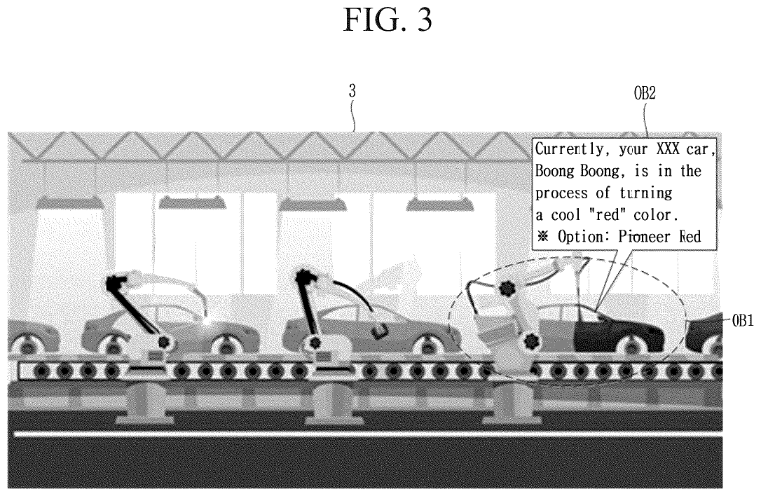

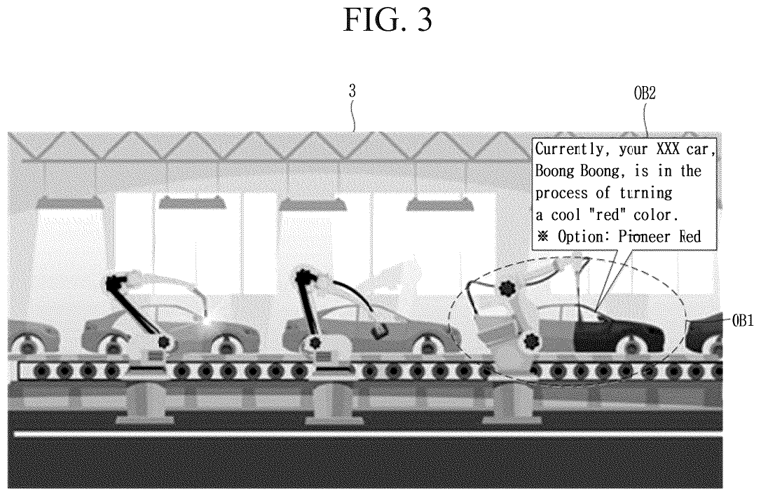

Hereinafter, an example method of providing a service for monitoring a manufacturing status of a vehicle by the system 10 will be described with reference to FIG. 6.

FIG. 6 is a diagram schematically illustrating a method of providing a service for monitoring a manufacturing status of a vehicle according to an embodiment. The method illustrated in FIG. 6 may be performed by the metaverse service operation system 300 described with reference to FIG. 1, for example.

Referring to FIG. 6, when the metaverse service operation system 300 receives an access request from a customer terminal 20 (operation S60), the metaverse service operation system 300 may perform a customer authentication procedure for a customer based on information received from the customer terminal 20 (operation S61). When the metaverse service operation system 300 does not successfully authenticate the customer (operation S62), the metaverse service operation system 300 may deny the access of the customer terminal 20 to the virtual environment operated by the metaverse service operation system 300 (operation S68).

When the metaverse service operation system 300 successfully authenticates the customer (operation S62), the metaverse service operation system 300 may verify whether the authenticated customer is a purchasing customer (operation S63). When the authenticated customer is not a vehicle purchasing customer, the metaverse service operation system 300 may allow the customer terminal 20 access to the virtual environment operated by the metaverse service operation system 300, but may limit and provide some of the functions provided by the virtual environment (operation S69).

When the authenticated customer is a vehicle purchasing customer, the metaverse service operation system 300 may allow access to the virtual environment (operation S64). In this case, the virtual environment that the customer is allowed to access may be a virtual environment built while being customized for the customer. The metaverse service operation system 300 may select a virtual factory model of the factory that produces a customer's vehicle from among virtual factory models stored in the virtual environment database 312, and build a customized virtual environment for the customer by using the selected virtual factory model.

When the customer's terminal 20 is allowed to access the virtual environment, the metaverse service operation system 300 may interlock or interface with the production management system 200 to obtain information on the actual vehicle manufacturing status of the vehicle purchased by that customer (operation S65). In other words, the production management system 200 may transmit customer information including unique identification information of the vehicle purchased by the customer from the production management system 200 and the metaverse service operation system 300 receives production work status information corresponding to the corresponding vehicle from the production management system 200 to obtain vehicle manufacturing status information of the customer's vehicle.

The metaverse service operation system 300 may synchronize the virtual environment with the manufacturing status of the customer vehicle when the manufacturing status information of the customer vehicle is obtained (operation S66). Based on the work status information of the vehicle, the customer may see what work is currently in progress on the customer's vehicle and the extent to which the work is completed. The metaverse service operation system 300 may then update the virtual space by locating the customer vehicle in the virtual space where the work currently being performed on the customer vehicle in the virtual environment is being performed, and by adding animation effects, actual work image, and the like depicting the work being performed on the customer vehicle to the virtual environment.

When the virtual environment is synchronized with the vehicle manufacturing status of the customer vehicle, the metaverse service operation system 300 may provide the synchronized virtual environment to the customer terminal 20 (operation S67). In other words, the metaverse service operation system 300 may transmit the data required to reproduce the synchronized virtual environment on the customer terminal 20 to the customer terminal 20.

According to an embodiment, the metaverse service operation system 300 may allow vehicle purchasing customers to watch the manufacturing process of the vehicle they purchased in the metaverse environment, and it can thereby increase the customer's attachment and familiarity with the vehicle, generate interest of customers, and reduce purchase cancellation rates. Additionally, the metaverse service operation system 300 may allow customers to monitor inspection results for their own vehicles in the metaverse environment, and it can thereby increase trust in the vehicles. In addition, according to an embodiment, by supporting the communication function between customers and workers in the metaverse environment, it can be possible to improve the quality of vehicle assembly by motivating workers to produce. In addition, according to an embodiment, by utilizing the metaverse environment for marketing, it can be possible to effectively enhance a corporate image and increase marketing effectiveness.

While example embodiments have been described in connection with what is presently considered to be practical, it can be understood that embodiments are not necessarily limited to the disclosed example embodiments.

What is claimed is:

1. A system comprising:
a production management system configured to monitor an assembly process progress state of a vehicle to generate work status information; and
a metaverse service operation system configured to build a metaverse environment to include a virtual factory environment modeled as an image-based virtual space of a factory where the vehicle is manufactured, to update the metaverse environment to depict a process currently in progress for the vehicle within the virtual factory environment based on the work status information, and to transmit data for executing the metaverse environment to a terminal of a customer.

2. The system of claim 1, wherein the metaverse service operation system is further configured to place a graphical object representing the vehicle in an area within the virtual factory environment where the process currently in progress is being performed, and to depict the process currently in progress by using the graphical object.

3. The system of claim 1, wherein the metaverse service operation system is further configured to identify a module being assembled in the vehicle based on the work status information, and to provide information about the module in the metaverse environment.

4. The system of claim 1, wherein, in response to the vehicle having left a factory and being transported, the metaverse service operation system is further configured to update the metaverse environment to depict a situation where the vehicle is being transported in the metaverse environment.

5. The system of claim 1, wherein the metaverse service operation system is further configured to build the metaverse environment to further include a virtual vehicle depicted to have a same vehicle environment as the vehicle.

6. The system of claim 1, wherein the metaverse service operation system is further configured to build the metaverse environment to further include at least one item for providing promotional information.

7. The system of claim 1, wherein the metaverse service operation system is further configured to build the metaverse environment to include a virtual market for selling customization components or modules, and to transmit information about purchased customization components or modules to the production management system such that the customization components or modules purchased by the customer in the virtual market are actually mounted in the vehicle.

8. The system of claim 1, wherein, in response to a non-purchasing customer who has not purchased a vehicle attempting to access the metaverse environment, the metaverse service operation system is further configured to restrict access of the non-purchasing customer to some functions provided by the metaverse environment.

9. The system of claim 1, wherein the metaverse service operation system is further configured to build the metaverse environment to include an avatar of the customer, and to implement the avatar to perform certain activities within the metaverse environment through interaction with the terminal.

10. The system of claim 1, wherein the metaverse service operation system is further configured to add a character representing the vehicle within the metaverse environment, to set a character name for the character through interaction with the terminal, and to give a conversation function with the terminal to the character.

11. The system of claim 1, wherein, in response to a message to be transmitted to a worker assembling the vehicle being received from the terminal, the metaverse service operation system is further configured to transmit the message to a terminal of the worker.

12. A method comprising:
building a metaverse environment to include a virtual factory environment modeled as an image-based virtual space of a factory where a vehicle is manufactured;
monitoring an assembly process progress state of the vehicle to generate work status information;
updating the metaverse environment to depict the assembly process currently in progress for the vehicle within the virtual factory environment based on the work status information; and
transmitting data for executing the metaverse environment to a terminal of a customer.

13. The method of claim 12, wherein the updating comprises:
placing a graphical object representing the vehicle of the customer in a virtual area within the virtual factory environment corresponding to an actual area where the assembly process currently in progress is being performed; and
adding a graphical effect that depicts the assembly process currently in progress to the metaverse environment.

14. The method of claim 12, further comprising:
performing an authentication procedure for the customer based on information received from the terminal; and
blocking access of the terminal to the metaverse environment in response to authentication of the customer failing.

15. The method of claim 12, further comprising:
restricting access of a non-purchasing customer who has not purchased a vehicle to some functions provided by the metaverse environment in response to the non-purchasing customer attempting to access the metaverse environment.

16. A method comprising:
building a metaverse environment to include a virtual factory environment modeled as an image-based virtual space of a factory where a vehicle is manufactured;
monitoring an assembly process progress state of the vehicle to generate work status information;
updating the metaverse environment to depict the assembly process currently in progress for the vehicle within the virtual factory environment based on the work status information;
placing a graphical object representing the vehicle of a customer in a virtual area within the virtual factory environment corresponding to an actual area where the assembly process currently in progress is being performed;
adding a graphical effect that depicts the assembly process currently in progress to the metaverse environment; and
transmitting data for executing the metaverse environment to a terminal of the customer.

17. The method of claim 16, further comprising:
performing an authentication procedure for the customer based on information received from the terminal; and
blocking access of the terminal to the metaverse environment in response to authentication of the customer failing.

18. The method of claim 16, further comprising restricting access of a non-purchasing customer who has not purchased a vehicle to some functions provided by the metaverse environment in response to the non-purchasing customer attempting to access the metaverse environment.
